(19) United States
(12) Patent Application Publication
(10) Pub. No.: US 2006/0190699 A1
(43) Pub. Date: Aug. 24, 2006

(54) Method, medium, and apparatus transforming addresses of discs in a disc drive

(75) Inventor: Yeong-kyun Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/320,947

(22) Filed: Dec. 30, 2005

(30) Foreign Application Priority Data
Jan. 19, 2005 (KR) 10-2005-0005073

(51) Int. Cl. G06F 12/10; G11B 21/02

(52) U.S. Cl. 711/202; 360/75

(57) ABSTRACT

A method, medium, and apparatus transforming a logical address of a disc. The method includes mapping a plurality of physical addresses to a plurality of logical addresses with reference to the data transmission speeds of the heads so that a physical address for a head having a higher data transmission speed is mapped to a relatively lower logical address, and transforming logical addresses of the disc drive into physical addresses with reference to the mapping results. Accordingly, it is possible to minimize fluctuations in the data transmission speed of the disc drive whenever the disc drive switches heads.

### CROSS-REFERENCE TO RELATED APPLICATIONS

This application claims the priority benefit of Korean Patent Application No. 10-2005-0005073, filed on Jan. 19, 2005, in the Korean Intellectual Property Office, the disclosure of which is incorporated herein in its entirety by reference.

### BACKGROUND OF THE INVENTION

1. Field of the Invention

Embodiments of the present invention relate to a method, medium, and apparatus transforming an address of discs in a disc drive, and more particularly, a method, medium, and apparatus transforming an address of discs in a disc drive that has different properties for different heads.

2. Description of the Related Art

In general, today hard disc drives (HDDs) include a plurality of heads, with the heads respectively recording and/or reading data to/from portions of different hard discs.

As an example, a plurality of tracks may be formed on the surface of a hard disc in concentric circles. Each track may be sectioned for recording data on the hard disc, e.g., track numbers 0, 1, . . . , may be sequentially allotted to respective tracks from the outermost circumferential track to the innermost circumferential track.

Here, a plurality of consecutive tracks may make up a “zone,” and a plurality of zones may be formed on a hard disc, e.g., on the surface of the hard disk. Similar to above, zone numbers 0, 1, . . . , may be sequentially allotted to respective zones ranging from the outermost zone to the innermost zone.

Again, an HDD may be made up of a stack of a plurality of hard discs, such that tracks of the hard discs having the same track number may be aligned with one another, thereby forming a cylinder. Accordingly, there are many cylinders in a HDD, just as there are many tracks on each of the hard discs, and thus, cylinder numbers 0, 1, . . . , can similarly be sequentially allotted to respective cylinders ranging from the outermost circumferential cylinder to the innermost circumferential cylinder. Accordingly, a track of one of the hard discs may be more specifically identified by a head number and a cylinder number.

As a track can be divided into a plurality of sectors, a typical operation of reading data from or writing data to a hard disc may be carried out in units of sectors.

With the above in mind, a cylinder head sector (CHS) method has been used for addressing sectors. In the CHS method, a plurality of physical addresses corresponding to a cylinder, a head, and a sector are sequentially designated, and then data is accessed through the physical addresses. However, the number of CHS parameters that can be designated for an HDD by a host is limited. Thus, a logical block address (LBA) method is more commonly used, where cylinders, heads, and sectors of an HDD are respectively represented by logical serial numbers starting from 0.

In the LBA method, LBAs of an HDD are transformed into physical addresses so that data can be accessed at the physical address level. Thus, in general, an HDD address transformation method is a method of transforming an LBA of an HDD into a physical address.

Conventionally, the plurality of heads included in an HDD were generally identical in terms of, for example, their capability of accessing a number of bits per inch, a number of tracks per inch, a number of tracks, and a number of sectors per track, and thus, conventionally achieved the same data transmission speeds. Accordingly, in a conventional HDD address transformation method, the data transmission speed of heads of an HDD is not taken into consideration.

However, recently HDDs have been manufactured to have a plurality of heads that have different capabilities and thus achieve different data transmission speeds. Thus, when using the conventional HDD address transformation method, the data transmission speeds of the HDD may fluctuate whenever the HDD changes heads, e.g., in a sequential read or write operation.

According to the conventional HDD address transformation method, a relatively lower LBA of an HDD equipped with a plurality of heads having different capabilities may be transformed into a physical address of one of the respective heads that achieves a relatively low data transmission speed. However, many test programs test the performance of an HDD mostly using relatively low LBAs of the HDD. As another example, system programs, directories, or file allocation tables that are frequently used in an operating system (OS) are also generally located at low LBAs of the HDD. Thus, limiting these operations to relatively low data transmission speed heads may not be advantageous.

Therefore, the conventional HDD address transformation method may not be efficient any longer when dealing with an HDD equipped with a plurality of heads having different capabilities and/or when operating an OS, for example.

### SUMMARY OF THE INVENTION

Embodiments of the present invention provide a method, medium, and apparatus, including a HDD, transforming an address of a disc drive equipped with a plurality of heads achieving different data transmission speeds, thereby minimizing fluctuations in the data transmission speed of the disc drive by mapping logical addresses to physical addresses in full consideration of the different data transmission speeds of the respective heads.

To achieve the above and/or other aspects and advantages, embodiments of the present invention include a method of transforming an address of a disc drive, the method including mapping a plurality of physical addresses to a plurality of logical addresses, with reference to data transmission speeds of heads of the disc drive, so that a physical address for one head having a higher data transmission speed than another head is mapped to a lower logical address than the head having the lower data transmission speed, and transforming logical addresses of the disc drive into physical addresses with reference to the mapping of the plurality of physical addresses to the plurality of logical addresses.

The mapping of the plurality of physical addresses to the plurality of logical addresses may include sorting out a number of sectors per track of heads of the disc drive, and mapping the plurality of physical addresses to the plurality of logical addresses includes mapping with reference to the number of sectors per track of the heads of the disc drive.

The transforming of the logical addresses of the disc drive may include recording a mapping table formed based on the mapping of the plurality of physical addresses to the plurality of logical addresses, and transforming the logical addresses of the disc drive into physical addresses with reference to the mapping table.

In addition, in the recording of the mapping table, the mapping table may be recorded in a system cylinder of the disc drive.

Further, the transforming of the logical addresses of the disc drive into the physical addresses may further include performing the transforming during a manufacturing stage of the disc drive before a consumer usage stage.

To achieve the above and/or other aspects and advantages, embodiments of the present invention include a disc drive, including a plurality of heads, each having different data transmission speeds, and a controller to transform, with reference to the data transmission speeds of the heads, a lower logical address for one head into a physical address for the one head, the one head having a higher data transmission speed than another head.

The controller may transform the lower logical address into the physical address for the one head based on the one head being relative to a larger number of sectors per track than number of sectors per track for the other head.

The disc drive may further include a disc to store a mapping table that maps a plurality of physical addresses to a plurality of logical addresses with reference to the data transmission speeds of the heads, wherein the controller transforms a logical address into a physical address with reference to the mapping table.

The disc may store the mapping table in a system cylinder. In addition, the disc drive may include a memory to store the mapping table downloaded from the disc when power is applied to the disc drive.

To achieve the above and/or other aspects and advantages, embodiments of the present invention include a disc drive controller to transform, with reference to the data transmission speeds of read/write heads, a lower logical address for one head into a physical address for the one head, the one head having a higher data transmission speed than another head.

The controller may transform the lower logical address into the physical address for the one head based on the one head being relative to a larger number of sectors per track than number of sectors per track for the other head.

To achieve the above and/or other aspects and advantages, embodiments of the present invention include a disc drive including a plurality of read/write heads to record and/or reproduce data from a medium, and a controller according to an embodiment of the present invention.

To achieve the above and/or other aspects and advantages, embodiments of the present invention include a method of recording and/or reproducing data based on a transforming of an address of a recording and/or reproducing apparatus, wherein a mapping of a plurality of physical addresses to a plurality of logical addresses, with reference to data transmission speeds of heads of the recording and/or reproducing apparatus, has been mapped such that a physical address for one head having a higher data transmission speed than another head is mapped to a lower logical address than the other head having the lower data transmission speed, the method including recording and/or reproducing data from a medium based on the mapped addresses.

To achieve the above and/or other aspects and advantages, embodiments of the present invention include a medium including computer readable code to implement embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a hard disc drive (HDD), according to an embodiment of the present invention;

FIG. 1B illustrates an electrical circuit of an HDD, such as that of FIG. 1A, according to an embodiment of the present invention;

FIG. 2A graphically illustrates various transmission speeds achieved by a plurality of heads of a typical HDD having different properties;

FIG. 2B graphically illustrates sequential read or write operation results obtained by implementing a conventional address transformation method in an HDD;

FIG. 3 illustrates an address transformation method, according to an embodiment of the present invention;

FIG. 4 graphically illustrates sequential read or write operation results obtained by implementing an address transformation method, such as that of FIG. 3, according to an embodiment of the present invention; and

FIGS. 5A and 5B graphically compare a performance of an address transformation method of the present invention, such as that of FIG. 3, with a performance of a conventional address transformation method using a performance test program, respectively.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below to explain the present invention by referring to the figures.

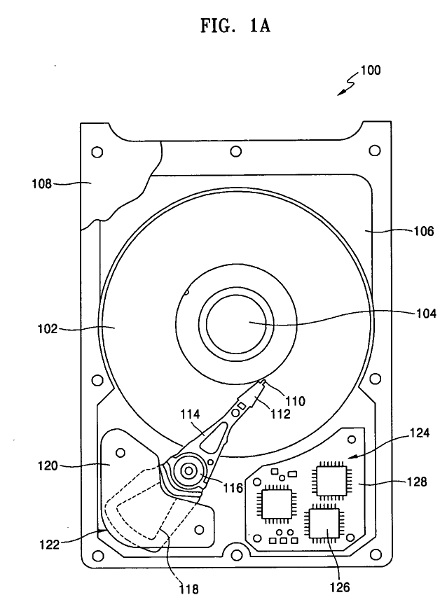

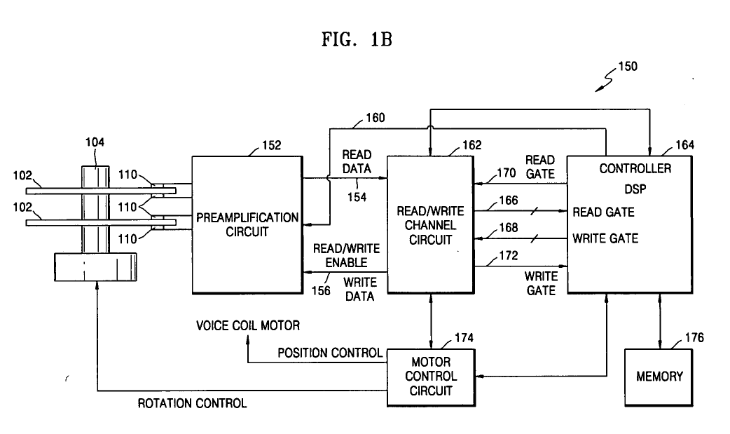

FIG. 1A illustrates a hard disc drive (HDD) 100, according to an embodiment of the present invention. Referring to FIG. 1A, the HDD 100 may include at least one magnetic disc 102 to be rotated by a spindle motor 104.

The spindle motor 104 may be installed on a base plate 106 of the HDD 100, and the HDD 100 may also include a cover 108 that covers the magnetic disc 102.

The HDD 100 may further include a plurality of heads 110, with each of the heads 110 being located in the vicinity of their respective magnetic disc 102, for example. Each of the heads 110 may include write and/or read devices, e.g., transducers, (not shown) that can generate and sense magnetic fields.

Each of the heads 110 may be installed on a flexure 112, making up a head gimbal assembly (HGA), to maintain a horizontal state for each head. Here, an actuator arm 114 may be attached to the flexure 112 and installed on a base plate 106 to be capable of being rotated upon a bearing assembly 116.

The heads 110 may have different capabilities from one another. For example, the different capabilities of the heads may relate to different numbers of bits per inch, different numbers of tracks per inch, different numbers of tracks, and different number of sectors per track. Accordingly, the differing heads 110 may achieve different data transmission speeds. Such differences among the heads 110 may be recorded in a system cylinder of the magnetic disc 102.

A voice coil 118 may be connected to a magnetic assembly 120 and make up a voice coil motor (VCM) 122. When a current is applied to the voice coil 118, a torque is generated to rotate the actuator arm 114 and the heads 110 move across the surface of the magnetic disc 102.

The HDD 100 may also include a printed circuit board (PCB) assembly 124, with the PCB assembly 124 potentially including a plurality of integrated circuits 126 connected to a PCB 128. The PCB 128 can be connected to the voice coil 118, the heads 110, and the spindle motor 104 via wires (not shown), for example.

FIG. 1B illustrates an electrical circuit 150, e.g., for the HDD 100 of FIG. 1A. Referring to FIG. 1B, the electrical circuit 150 may include a preamplification circuit 152, with the preamplification circuit 152 including a read data channel 154 and a write data channel 156 connected to a read or write channel circuit 162.

The preamplification circuit 152 may include a read or write enable gate 160 connected to a controller 164, with data being written to or read from the magnetic disc 102 by enabling the read or write enable gate 160, for example.

The read or write channel circuit 162 may be connected to the controller 164 via the read and write channels 166 and 168 and read and write gates 170 and 172. Here, the read gate 170 is enabled when data needs to be read from the magnetic disc 102, and the write gate 172 is enabled when data needs to be written to the magnetic disc 102.

As an example, the controller 164 may be a digital signal processor that operates according to predetermined software routines. Here, as an example, the software routines may include routines for writing data to or reading data from the magnetic disc 102.

The respective read or write channel circuit 162 and the controller 164 may be connected to a motor control circuit 174 that controls the VCM of the HDD 100 and the spindle motor 104.

The controller 164 may also be connected to a non-volatile memory device 176. As only an example, the non-volatile memory device 176 may be a read-only memory (ROM). The non-volatile memory device 176 may store commands needed for operating the controller 164 and the HDD 100. Alternatively, the controller 164 may include a firmware program that can operate the HDD 100, noting that additional embodiments are equally available.

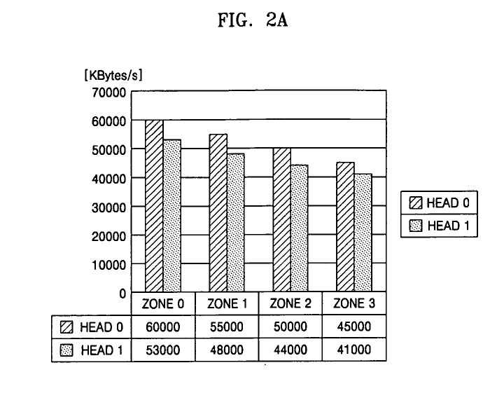

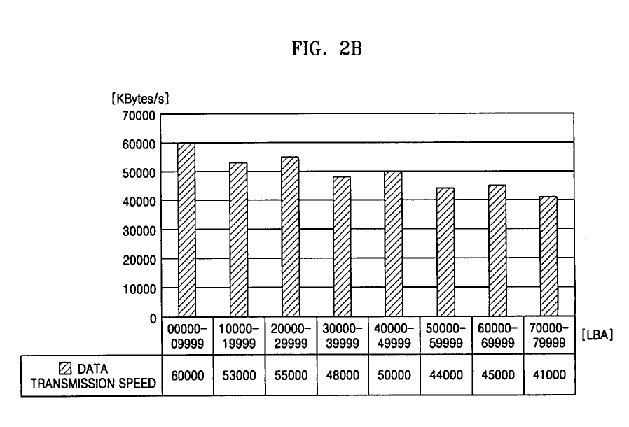

FIG. 2A graphically illustrates various transmission speeds achieved by a plurality of heads of a typical HDD having different capabilities. Referring to FIG. 2A, zones 0 through 3 may be zones formed on a hard disc. Head 0 may be a head facing one surface, e.g., an upper side or one portion, of the hard disc, and head 1 may be a head facing the other surface, e.g., a lower side or another portion, of the hard disc. The zone number and head number can be used to make up a physical block address (PBA).

In zone 0, head 0 may have a data transmission speed of 60,000 Kbytes/s, and head 1 may have a data transmission speed of 53,000 Kbytes/s. In zone 1, head 0 may have a data transmission speed of 55,000 Kbytes/s, and head 1 may have a data transmission speed of 48,000 Kbytes/s. In zones 2 and 3, heads 0 and 1 may similarly have different data transmission speeds.

In short, heads 0 and 1 can have different data transmission speeds in all of zones 0 through 3, e.g., because heads or the underlying media/disc, or portion of the same, may have different properties from each other, e.g., they may have a different number of bits per inch, different number of tracks per inch, different number of tracks, and/or different number of sectors per track. Particularly, the number of sectors per track corresponding to each head may be closely related to the data transmission speed of the head.

As an example, the data transmission speeds provided by heads 0 and 1 may be arranged in a descending order as follows: 60,000 Kbytes/s achieved in zone 0 by head 0; 55,000 Kbytes/s achieved in zone 1 by head 0; 53,000 Kbytes/s achieved in zone 0 by head 1; 50,000 Kbytes/s achieved in zone 2/head 0; 48,000 Kbytes/s achieved in zone 1 by head 1; 45,000 Kbytes/s achieved in zone 3 by head 0; 44,000 Kbytes/s achieved in zone 2 by head 1; and 41,000 Kbytes/s achieved in zone 3 by head 1.

As discovered relative to the present invention, a plurality of PBAs, each having a zone number and a head number, could be arranged in the following order where the PBA from which a higher data transmission speed comes ahead of the PBA from which a lower data transmission speed: (zone 0, head 0); (zone 1, head 0); (zone 0, head 1); (zone 2, head 0); (zone 1, head 1); (zone 3, head 0); (zone 2, head 1); and (zone 3, head 1).

However, the conventional address transformation method does not take into consideration the data transmission speeds of heads 0 and 1. According to the conventional address transformation method, a plurality of logical block addresses (LBAs) are arranged simply in an ascending order as follows: (zone 0, head 0); (zone 0, head 1); (zone 1, head 0), (zone 1, head 1); (zone 2, head 0); (zone 2, head 1); (zone 3, head 0); and (zone 3, head 1).

FIG. 2B graphically illustrates sequential read or write operation results obtained by applying the conventional address transformation method to a HDD. Referring to FIG. 2B, the horizontal axis indicates LBAs, and the vertical axis indicates data transmission speeds achieved at the LBAs by a plurality of heads. Supposing that the HDD uses different heads every ten thousands LBAs, the data transmission speed of the HDD of FIG. 2A is 60,000 Kbytes/s in an LBA range of 00000 to 09999 and is 53,000 Kbytes/s in an LBA range of 10000 to 19999, which is lower than in the LBA range of 00000 to 09999.

As noted above, the data transmission speed of a HDD may be 55,000 Kbytes/s in an LBA range of 20000 to 29999, which is slightly higher than in the above noted LBA range of 10000 to 19999. The data transmission speed of the HDD also slightly fluctuates in other LBA ranges subsequent to the LBA range of 20000 to 29999, as shown in FIG. 2B.

In short, the data transmission speed of an HDD fluctuates when the HDD carries out a sequential read or write operation using the conventional address transformation method.

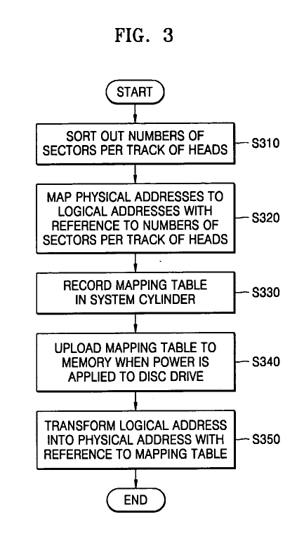

FIG. 3 illustrates an address transformation method according to an embodiment of the present invention. Referring to FIG. 3, in operation S310, the number of sectors per track of a plurality of tracks of a disc drive may be sorted out. The number of tracks per head of a head is closely related to the data transmission speed of the head. In general, the larger the number of sectors per track of a head, the higher the data transmission speed of the head.

In operation S320, physical addresses of the disc drive may be mapped to logical addresses of the disc drive with reference to the number of sectors per track of the heads. Physical addresses dealt with by a head having a relatively larger number of sectors per track may be mapped to relatively lower logical addresses. In other words, physical addresses dealt with a head having a higher data transmission speed may be mapped to relatively lower logical addresses.

For example, a plurality of LBAs may be arranged in an ascending order and then respectively applied to (zone 0, head 0), (zone 1, head 0), (zone 0, head 1), (zone 2, head 0), (zone 1, head 1), (zone 3, head 0), (zone 2, head 1), (zone 3, head 1), . . . of a HDD.

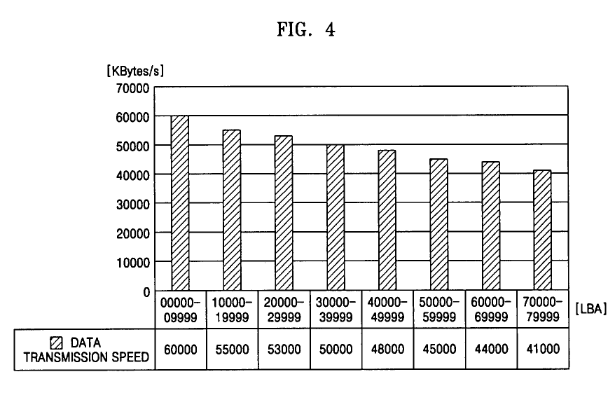

FIG. 4 graphically illustrates sequential read or write operation results obtained by applying an address transformation method, such as that of FIG. 3, to a HDD. Referring to FIG. 4, for convenience of explanation it will be assumed that the HDD uses different heads every ten thousands of LBAs, such that the data transmission speed of the HDD is 60,000 Kbytes/s in an LBA range of 00000 to 09999 and is 55,000 Kbytes/s in an LBA range of 10000 to 19999, which is lower than in the LBA range from 00000 to 09999. Similarly, the data transmission speed of the HDD may be 53,000 Kbytes/s in an LBA range of 20000 to 29999, which is also lower than in the LBA range of 10000 to 19999. The data transmission speeds of the HDD gradually, but very slightly, may, thus, decrease in other LBA ranges subsequent to the LBA range of 20000 to 29999.

Therefore, the data transmission speed of the HDD, according to an embodiment of the present invention, gradually decreases, rather than fluctuating, when the HDD carries out a sequential read or write operation using an address transformation method, e.g., such as that of FIG. 3, and thus, it is possible to overcome the problem with the conventional address transformation method, i.e., fluctuations in the data transmission speed of an HDD.

Referring to FIG. 3, in operation S330, a mapping table obtained in operation S320 may be recorded in a system cylinder of a disc drive. Operations S310 through S330 may be carried out in a middle of a manufacturing process of the disc drive, for example.

In operation S340, when power is applied to the disc drive, the disc drive may upload the mapping table recorded in a system cylinder to a memory. In operation S350, the disc drive may transform a logical address into a physical address, if necessary, with reference to the uploaded mapping table.

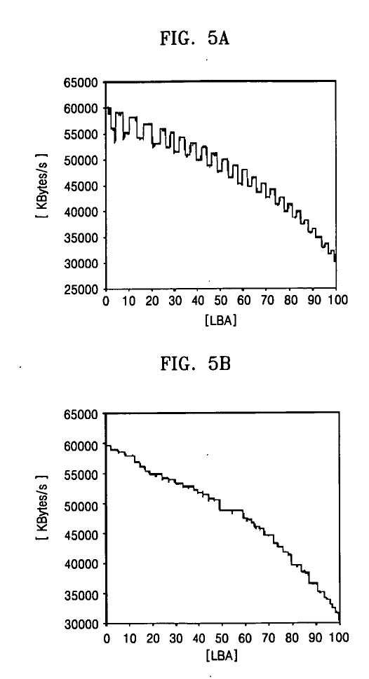

FIGS. 5A and 5B graphically compare the performance of an address transformation method of the present invention, such as that of FIG. 3, with the performance of the conventional address transformation method using a performance test program. Specifically, FIG. 5A illustrates testing results of the conventional address transformation method, and FIG. 5B illustrates testing results of an address transformation method according to an embodiment of the present invention. Referring to FIGS. 5A and 5B, the horizontal axis indicates LBAs, and the vertical axis indicates data transmission speeds of heads.

As shown in FIGS. 5A and 5B, the data transmission speed of the HDD severely fluctuates in the conventional method of FIG. 5A, while less severely fluctuating in the method of FIG. 5B.

Various head properties, other than the number of sectors per track, may be taken into consideration when forming a mapping table for physical addresses and logical addresses. In addition, the mapping table may be formed based on a result of directly measuring the data transmission speed of each head, for example.

As described above, according to embodiments of the present invention, it is possible to minimize fluctuations in the data transmission speed of an HDD equipped with a plurality of heads having different properties in a sequential read or write operation whenever the HDD switches heads. In addition, it is possible to enhance the performance of the HDD or an OS by mapping physical addresses dealt with by heads with higher data transmission speeds to relatively lower LBAs.

In addition to the above described embodiments, embodiments of the present invention can also be implemented through computer readable code/instructions in/on a medium, e.g., a computer readable medium. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The media may also be a distributed network, so that the computer readable code is stored/transferred and executed in a distributed fashion.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of transforming an address of a disc drive, the method comprising:
mapping a plurality of physical addresses to a plurality of logical addresses, with reference to data transmission speeds of heads of the disc drive, so that a physical address for one head having a higher data transmission speed than another head is mapped to a lower logical address than the head having the lower data transmission speed; and
transforming logical addresses of the disc drive into physical addresses with reference to the mapping of the plurality of physical addresses to the plurality of logical addresses.

2. The method of claim 1, wherein the mapping of the plurality of physical addresses to the plurality of logical addresses comprises:
sorting out a number of sectors per track of heads of the disc drive; and
mapping the plurality of physical addresses to the plurality of logical addresses comprises mapping with reference to the number of sectors per track of the heads of the disc drive.

3. The method of claim 1, wherein the transforming of the logical addresses of the disc drive comprises:
recording a mapping table formed based on the mapping of the plurality of physical addresses to the plurality of logical addresses; and
transforming the logical addresses of the disc drive into physical addresses with reference to the mapping table.

4. The method of claim 3, wherein in the recording of the mapping table, the mapping table is recorded in a non-volatile memory.

5. The method of claim 1, wherein the transforming of the logical addresses of the disc drive into the physical addresses further comprising performing the transforming during a manufacturing stage of the disc drive before a consumer usage stage.

6. A disc drive, comprising:
a plurality of heads, each having different data transmission speeds; and
a controller to transform, with reference to the data transmission speeds of the heads, a lower logical address for one head into a physical address for the one head, the one head having a higher data transmission speed than another head.

7. The disc drive of claim 6, wherein the controller transforms the lower logical address into the physical address for the one head based on the one head being relative to a larger number of sectors per track than number of sectors per track for the other head.

8. The disc drive of claim 6, further comprising a non-volatile memory to store a mapping table that maps a plurality of physical addresses to a plurality of logical addresses with reference to the data transmission speeds of the heads,
wherein the controller transforms a logical address into a physical address with reference to the mapping table.

9. The disc drive of claim 8, wherein the non-volatile memory could be a system cylinder in the disc or flash memory.

10. The disc drive of claim 8, further comprising a memory to store the mapping table downloaded from the non-volatile memory when power is applied to the disc drive.

11. A disc drive controller to transform, with reference to the data transmission speeds of read/write heads, a lower logical address for one head into a physical address for the one head, the one head having a higher data transmission speed than another head.

12. The controller of claim 11, wherein the controller transforms the lower logical address into the physical address for the one head based on the one head being relative to a larger number of sectors per track than number of sectors per track for the other head.

13. A disc drive comprising:
a plurality of read/write heads to record and/or reproduce data from a medium; and
the controller of claim 11.

14. A method of recording and/or reproducing data based on a transforming of an address of a recording and/or reproducing apparatus, wherein a mapping of a plurality of physical addresses to a plurality of logical addresses, with reference to data transmission speeds of heads of the recording and/or reproducing apparatus, has been mapped such that a physical address for one head having a higher data transmission speed than another head is mapped to a lower logical address than the other head having the lower data transmission speed, the method comprising:
recording and/or reproducing data from a medium based on the mapped addresses.

15. A medium comprising computer readable code to implement the method of claim 1.

16. A medium comprising computer readable code to implement the method of claim 14.

17. The method of claim 3, wherein the non-volatile memory is flash memory or a system cylinder of the disc drive.
